(19) United States
(12) Patent Application Publication
(10) Pub. No.: US 2011/0102534 A1
(43) Pub. Date: May 5, 2011

(54) PRINT HEAD FOR A THERMAL PRINTER, METHOD FOR PRODUCTION THEREOF, AND THERMAL PRINTER INCORPORATING SAME

(75) Inventors: ERWIN TISLER, Villingen-Schwenningen (DE); Eberhard Hauser, Villingen-Schwenningen/Weigheim (DE); Ralph Landowski, Frittlingen (DE)

(73) Assignee: Carl Valentin GmbH, Villingen-Schwenningen (DE)

(21) Appl. No.: 12/641,086

(22) Filed: Dec. 17, 2009

(30) Foreign Application Priority Data
Nov. 5, 2009 (EP) EP 09 013898.3

(51) Int. Cl. B41J 2/35

(52) U.S. Cl. 347/211

(57) ABSTRACT

The invention is a print head for a thermal printer having a print region, a plurality of heating elements arranged in the print region, and actuating electronics by which the heating elements can be actuated. One or more additional heating elements are arranged outside the print region, wherein at least one of the additional heating elements has a property, that differs from a normal property, of the heating elements arranged in the print region. There is included a method for production of the print head. The device electronics further comprises a testing circuit for verification of the print head, in which the print head has one or more additional heating elements whose properties differ in regard to at least one normal property of the heating elements and the testing circuit for verification of the print head is designed to check this property at least on some of the heating elements.

### CROSS REFERENCE TO RELATED APPLICATIONS

This application claims priority from European Patent Application Serial No. 09 013898.3, filed Nov. 5, 2009, the entire contents of which is herein incorporated fully by reference.

### FIGURE FOR PUBLICATION

FIG. 1A.

### BACKGROUND OF THE INVENTION

1. Field of the Invention

The present invention relates to a print head for a thermal printer and the method of making the print head. More specifically, the present invention relates to a print head for a thermal printer with a print region for imprinting a print medium, a plurality of heating elements arranged in at least one line in the print region, and actuating electronics. The print head further comprises one or more additional heating elements arranged outside the print region, wherein at least one of the additional heating elements has a property that differs from a normal property of the heating elements arranged in the print region.

2. Description of the Related Art

The term thermal printer in the sense of this patent application comprises printers in which the desired local heating of the print head brings about a color change on the medium being printed directly or indirectly. Three subcategories of such printers are currently of practical significance: thermodirect printers; thermotransfer printers; and, thermosublimation printers.

In thermodirect printers, a special heat-sensitive print medium is used, which changes color at a place where the print head is heated locally. Thermodirect printers enable a fast and cheap printing process with a very simple layout of the printer; their main drawback is that the print medium is sensitive to light and temperature in the long term, so that often aging processes occur in the print medium, which may have the result that a printout is no longer legible after a long time, such as several years.

Thermotransfer printers are distinguished in that they can achieve a very high resolution of the print image and therefore they find broad use.

The basic principle of thermotransfer printing is that a special ink film with an ink layer, the thermotransfer film, is led between the medium being printed and the print head. The printing mechanism of the print head usually extends over the entire width of the medium being printed upon; the print widths are standardized. The print head, more specifically the printing mechanism of the print head, has a plurality—typically over 1000—of heating elements, which are typically designed with pointlike heads, or so-called “dots”, and arranged in a line. The individual heating elements are activated by actuation electronics, which processes the print data received via the printer from the host computer. If a heating element is actuated, its head is heated, and as a consequence the ink layer melts and the ink is transferred to the medium being printed.

The heating elements must be actuated quickly and with high precision. Basically, it is desirable to print as fast as possible; at present, a printing of up to 1000 mm of print medium per second can be achieved. With a print quality of 300 dpi (dots per inch), an ink spot must be laid down every 0.085 mm, which means that even disregarding the [missing word—likely “time”] for feeding of the print medium and the ink transfer film, the melting and ink transfer process must be completed in less than one millisecond.

Thermo sublimation printers are similar to thermotransfer printers in their basic principle. In contrast to thermotransfer printing, with thermosublimation printing the ink layer deposited on the substrate film is directly evaporated by furnishing heat (sublimated). The ink gas then penetrates into the material being printed or is precipitated thereupon. The quantity of ink transferred depends decisively on the energy supplied by the heating element, which makes it possible to work with very high color resolution, but at the same time requires a very exact actuation of the print head.

Of critical importance to the print quality achieved with all the aforementioned types of thermal printers is the use of print heads that are precisely attuned to the respective thermal printer. Only this can ensure that the color change of the print medium (in thermodirect printers) or the melting or evaporating of the ink layer (in thermotransfer or thermosublimation printers) will in fact occur in optimal manner in the time up to the next relative movement between print medium and print head or ink transfer film and print head, so that a satisfactory and high-quality printing outcome is achieved.

It is customary to provide print heads for thermal printers with a printer-specific coding, which is polled by the respective printer and an error message is sent if the polling reveals that the wrong code is present. The coding systems known thus far can basically be divided into two classes. On the one hand, mechanical codes in the form of a perforation pattern are used. But these are easy to imitate, as they can be easily evaluated visually. On the other hand, it is known how to arrange electronic codes on the print heads, for which a key number is saved in an electronic storage module, such as a flash memory or an EPROM, and the electronic storage module is read out during each printing process. But, what is not appreciated by the prior art is the relatively high expense associated with it, which leads to substantial costs.

Accordingly, there is a need for an improved print head for a thermal printer that can be encoded in a secure, and at the same time, economical manner, and a thermal printer with such a print head.

### ASPECTS AND SUMMARY OF THE INVENTION

An aspect of the present invention is to provide a print head for a thermal printer that can be encoded in a secure and at the same time economical manner, and the provision of a thermal printer with such a print head.

The problem is solved by a print head for a thermal printer with a print region for imprinting a print medium, a plurality of heating elements arranged in at least one line in the print region, and actuating electronics. The print head further comprises one or more additional heating elements arranged outside the print region, wherein at least one of the additional heating elements has a property that differs from a normal property of the heating elements arranged in the print region.

The print head for a thermal printer according to the invention has a print region for imprinting a print medium, a plurality of heating elements arranged in at least one line in the print region, an actuating electronics by which the heating elements can be actuated, and a plug connector. According to the invention, one or more additional heating elements are also arranged outside the print region, being likewise actuated by the actuating electronics, wherein at least one of the additional heating elements has a property, especially an electrical resistance, that differs from a normal property, especially the electrical resistance, of the heating elements arranged in the print region.

The basic notion of the invention thus consists in providing additional heating elements with respective actuating electronics outside of the print region, which is always clearly distinguishable on account of the customary use in thermal printers of a stationary print head and standardized widths of the medium being printed upon, and to achieve the coding in that properties, especially the electrical resistance, of a selection of these additional heating elements of the print head are specifically changed in a processing step.

By the print region of the print head is meant the region in which the print head can perform its intended function, i.e., where any given combination of dots can be used for the color change on the print medium. Explicitly included in the notion of the invention is therefore the possibility of decreasing the print region originally provided for a print head designed for a given usable width by modifying some of the heating elements arranged at the margin of the original print region in an additional processing step.

In view of the fact that typical print heads for thermal printers have over 1000 heating elements for the standard usable width of 104 mm, for example, corresponding to a spacing between individual dots formed by the heating elements of 0.085 mm for 300 dpi, the providing of a few additional heating elements is so slight in terms of cost as a reducing of the print region by a few dots, say, 2; but the coding formed by the specific selection or arrangement of the altered heating elements, and which can also vary within the same type of device, can only be ascertained with great expense and is therefore very secure.

To achieve good heat dissipation, it is advantageous for the print head to have an aluminum body.

An especially compact and easy to produce print head is obtained if the actuating electronics is integrated in a circuit board or in a substrate that is actuated by a circuit board. If utilizing an aluminum body, an especially good heat dissipation is achieved when the aluminum body lies at least partly on the circuit board and/or the substrate. In order not to impair the heat conduction by intermediate layers, it is especially advantageous in this case to connect the aluminum body to the circuit board at fastening points.

The method of the invention for production of a print head for a thermal to printer specifies at least the steps of preparing a substrate with a plurality of heating elements, having at least one line of heating elements, and an actuating electronics, by means of which the heating elements can be actuated; the establishing of a print region of the print head, in which a print medium can be imprinted by the print head, wherein the print region is established such that one or more heating elements lie outside the print region; and the producing of a specific change of properties of one or more of the heating elements lying outside the print region. The sequence of these steps is essentially variable. In particular, it is possible to carry out the steps in the above-indicated order; but it would also be possible to first specifically change a row of heating elements, then establish the print region on a substrate and then to mount heating elements whose property has been changed at one or more selected sites outside the print region during the preparation of the substrate.

A property which is especially easy to change by means of a thermal treatment is the resistance of one or more of the heating elements lying outside the print region. This can be done, in particular, by a specific supplying of current to the heating elements, which can be done in particular with an especially high current or for an especially long time.

One advantageous possibility of supplying the current is to control the current supply during the thermal treatment by the actuating electronics.

The thermal printer according to the invention has device electronics for actuating a print head and a print head which can be actuated by the device electronics with a plurality of heating elements, wherein the device electronics has a testing circuit for verification of the print head. The print head has one or more heating elements whose properties differ in regard to at least one normal property of the heating elements and the testing circuit for verification of the print head is designed to check this property at least on some of the heating elements.

Thus, with the help of the testing circuit, one can establish which heating elements have a deviation from the normal property. This outcome is then compared to a nominal outcome, which is deposited in the thermal printer, preferably in a storage element. If an outcome deviating from the nominal outcome is determined by the testing circuit, an error message is put out, which is shown in a printer display or on a monitor screen of a device controlling the printer, such as a computer or a computerized cash register. The error message can be a warning message that is temporarily or permanently acknowledged by a confirmation, or it can also prevent any further use of the printer.

An especially easy to realize testing is possible if the testing circuit for verification of the print head is designed to test the electrical resistance of at least some of the heating elements.

It is especially advantageous if the print head has a print region in which some of the heating elements are arranged at least in one line, while one or more additional heating elements are arranged outside the print region.

In one especially simple embodiment, the testing circuit is designed only for testing of heating elements that are arranged outside the print region.

A more costly embodiment calls for the testing circuit to be designed for the testing of all heating elements. This makes it possible, by means of the testing circuit for checking the coding, to perform a checking of the functional capability of the print head at the same time, since a deviation of a given heating element from the normal property, especially the resistance, leads to a deviation in the ink transfer.

The above, and other objects, features and advantages of the present invention will become apparent from the following description read in conjunction with the accompanying drawings, in which like reference numerals designate the same elements.

### BRIEF DESCRIPTION OF THE DRAWINGS

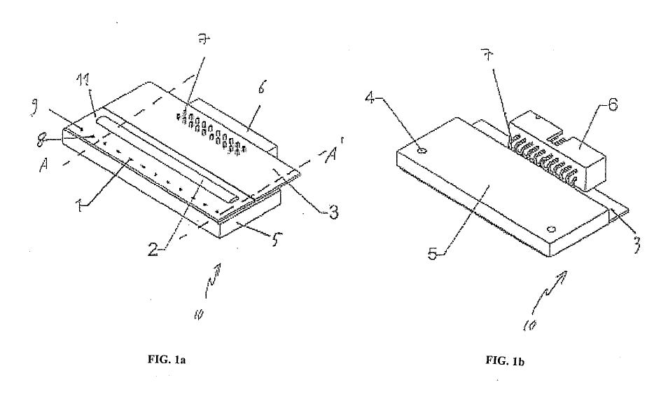

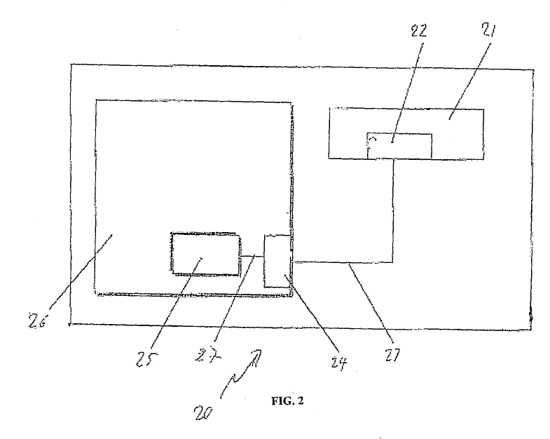

FIG. 1a is a pictorial representation of a print head for a thermal printer, shown slanted from below.

FIG. 1b is a pictorial representation of the print head of FIG. 1a, shown slanted from above.

FIG. 2 is a block diagram of the components of a thermal printer.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

F 1a shows a simplified representation of a print head 10 for a thermal printer, shown slanted from below as compared to its typical direction of installation. In other words, in FIG. 1a one is looking at the side of the print head 10 that faces the medium being imprinted during operation of the thermal printer. One notices a substrate 11, on or in which an actuating electronics 2 and a plurality of heating elements 1 oriented in line fashion are arranged. The simplification of the representation consists in that, in a real print head, a very much larger number of heating elements 1 is provided, typically more than 1000 heating elements 1 for print heads that are designed to imprint a print medium at a width of 104 mm.

The substrate 11 is arranged on a circuit board 3, by means of which the substrate can be actuated. In the perspective view of FIG. 1a, there is an aluminum block 5 underneath the circuit board 3 in surface contact with the underside of the circuit board 3 and the substrate 11. The circuit board 3 is studded with a number of contact pins 7, which communicate with the actuating electronics 2 via conductor tracks of the circuit board (not shown). The contact pins 7 lead to a plug connector 6, which serves to connect the print head to a thermal printer.

Moreover, two broken lines A, A′ are shown in FIG. 1a. The print region (A-A′) of the print head 10 lies between these two lines. Outside the print region are additional heating elements 8, 9—two in this simplified example—that can likewise be actuated by the actuating electronics 2. While the heating elements 1 are used to carry out the thermal printing, the additional heating elements 8, 9 serve for the coding of the print head. The deviation of a property of at least one of the additional heating elements 8, 9 from the corresponding property of the heating elements 1 is used as logical one and the agreement of the corresponding property is used as logical zero, or vice versa. Specifically, e.g., the resistance of the respective heating elements can be used, which can be influenced, specifically in regard to a normal resistance, by a deliberate thermal alteration of heating elements by supplying very high currents or for a lengthy time. For example, heating elements 1 with a normal resistance of 1 kΩ can be used and resistances of 2-10 kΩ can be produced in one or both of the additional heating elements 8, 9 by long-term supplying of current. This long-term current supply can come, for example, from an appropriate actuation by the actuating circuit 2.

Thus, for two additional heating elements 8, 9, there are four conceivable codes: both of the additional heating elements 8, 9 might have the normal resistance (code 00), the additional heating element 8 might have the normal resistance and the additional heating element 9 a deviating resistance (code 01), only the additional heating element 9 might have the normal resistance and the additional heating element 8 a deviating resistance (code 10), or both additional heating elements 8, 9 might have a deviating resistance (code 11).

FIG. 1b shows the print head 10 from FIG. 1a, seen from the opposite direction. From this direction, one looks at an aluminum block 5, which is arranged on a surface segment of a circuit board 3 and the substrate 11 concealed by the aluminum block 5 in FIG. 1b and fastened to the latter by fastening points 4. A plug connector 6 is connected by contact pins 7 to the circuit board or, more precisely, to conductor tracks of the circuit board (not shown).

FIG. 2 shows a block diagram of the components of a thermal printer 20. One notices a print head 21, for example, like that depicted in FIG. 1a and FIG. 1b, with a plug connector 22 arranged at the print head side and a device electronics 26, which has a testing circuit 25 for verification of the print head and a plug connector 24 at the device electronics side, connected to the testing circuit 25 via a signal pathway 27. A connection cable 23 connects the plug connector 22 arranged at the print head side and the plug connector 24 at the device electronics side.

The testing circuit 25 for verification of the print head is designed to check whether at least the additional heating elements 8, 9 have the normal property for the heating element 1, i.e., whether the heating elements 8 and 9 represent a logical one or a logical zero. This testing can be done, e.g., each time the thermal printer 20 is turned on or during each print command sent to the thermal printer 20.

For example, if a resistance of the heating element 1, 8, 9 of 1 kΩ is used as the normal property, the testing circuit could send commands to the actuating electronics 2 to apply in succession a definite voltage to each of the heating elements 1, 8, 9 of interest and then, if the actuating electronics is so designed, either to measure the resulting current flowing through the heating element 1, 8, 9 of interest and relay the measured value to the testing circuit 25, or to relay the response signal from the heating element 1, 8, 9 of interest via the connection cable to the testing circuit 25, which in this case evaluates the response signal either by a measurement of current or by comparison with a reference current corresponding to the normal signal.

In this way, the proper functioning of the heating element can be checked for heating elements 1 lying inside the print region. For the additional heating elements 8, 9 lying outside the print region, one determines in this way whether they represent a logical one or a logical zero.

In order to ascertain from this information whether the correct print head 10, 21 is being used, it is necessary to store the code for the correct print head 10, 21 in the device electronics 26, for example, in a storage element of the device electronics 26 or the testing circuit 25, and to make a comparison between the correct code and the code that is detected. In the present example, with only two additional heating elements 8, 9 for a given thermal printer 20, one of four different codes could be the correct one.

If the device electronics 26 ascertains that a print head 10, 21 with a wrong code has been installed, a corresponding alarm signal can be triggered on a display of the thermal printer 20 or a device in control of it. This can be, e.g., a warning message to the user that adequate print results cannot be achieved with the print head 10, 21, and it can be acknowledged permanently or for a certain length of time, e.g., 10 minutes. Of course, it is also conceivable that an alarm signal will result in termination of the print command, so that a thermal printer 20 with the wrong print head 10, 21 is no longer usable.

Which print head 10, 21 to be delivered when the current print head 10, 21 is used up can be determined by a certified replacement parts vendor, for example, by using a device number displayed when ordering a new print head 10, 21. A manufacturer of print heads 10, 21 that do not satisfy the quality standards does not receive this information. He must then either deliver a print head 10, 21 trusting to luck, which even with 2 additional heating elements 8, 9 is only successful in 25% of the cases, or the customer of the lower-quality manufacturer must temporarily hand over his printer to him so that he can test out all the possibilities.

Thus, the invention reliably ensures that an ideal print quality of a thermal printer 20 can be constantly achieved by use of the optimally adapted print head 10, 21.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1. A print head for a thermal printer with a print region for imprinting a print medium, said print head comprising:
(a) a first set of heating elements, said first set of heating elements further comprising a plurality of heating elements arranged in at least one line in said print region;
(b) a set of actuating electronics by which said plurality of heating elements can be actuated;
(c) a plug connector; and
(d) a second set of heating elements, said second set of heating elements further comprising one or more additional heating elements arranged outside of said print region, said second set of heating elements being likewise actuated by said set of actuating electronics, wherein at least one of said one or more additional heating elements has a property, especially an electrical resistance, that differs from a normal property, especially said electrical resistance, of said first set of heating elements.

2. A print head according to claim 1, wherein said print head has an aluminum body.

3. A print head according to claim 1, wherein said print head further comprises a circuit board, said circuit board for actuating said set of actuating electronics.

4. A print head according to claim 2, wherein said print head further comprises a circuit board, said circuit board for actuating said set of actuating electronics.

5. A print head according to claim 3, wherein said set of actuating electronics is integrated in a circuit board on or against which the heating elements are arranged and that can be actuated by said circuit board.

6. A print head according to claim 3, wherein said set of actuating electronics is integrated in a substrate on or against which said plurality of heating elements are arranged and wherein said set of actuating electronics can be actuated by a circuit board.

7. A print head according to claim 4, wherein said aluminum body lies at least partly on said circuit board.

8. A print head according to claim 4, wherein said aluminum body is connected to said circuit board at a corresponding set of fastening points.

9. A print head according to claim 6, wherein said aluminum body is connected to said substrate at a corresponding set of fastening points.

10. A method for production of a print head for a thermal printer, said method comprising the steps of:
(a) preparing a substrate with a plurality of heating elements, said plurality of heating elements having at least one line of heating elements, and a set of actuating electronics, by means of which said plurality of heating elements can be actuated;
(b) establishing a print region of said print head, in which a print medium can be imprinted by said print head, wherein said print region is established such that a set of one or more heating elements of said plurality of heating elements lie outside said print region; and
(c) producing a specific change of properties of said one or more heating elements of said plurality of heating elements lying outside of said print region.

11. A method according to claim 10, further comprising the step of changing of a property of said one or more heating elements of said plurality of heating elements is done by thermal treatment.

12. A method according to claim 11, wherein said changed property is the resistance of said set of one or more heating elements lying outside said print region.

13. A method according to claim 11, said method further comprising the step of applying said thermal treatment by supplying current to said set of one or more heating elements lying outside said print region.

14. A method according to claim 13, wherein said supplying of current during said thermal treatment is controlled by said set of actuating electronics.

15. A thermal printer, said thermal printer comprising:
(a) a set of device electronics for actuating a print head, said device electronics further comprising a testing circuit for verification of a performance standard of said print head; and
(b) said print head, which can be actuated by said device electronics, said print head further comprising:
(i) a plurality of heating elements; and
(ii) a set of one or more additional heating elements whose properties differ in regard to at least one normal property of said plurality of heating elements and wherein said testing circuit is designed to check said properties on at least a subset of said set of one or more additional heating elements.

16. A thermal printer according to claim 15, wherein said print head has a print region in which each of the members of a subset of said plurality of heating elements is arranged at least in one line, while each one of said set of one or more additional heating elements are arranged outside said print region.

17. A thermal printer according to claim 16, wherein said testing circuit is designed only for testing of said set of one or more additional heating elements.

18. A thermal printer according to claim 15, wherein said testing circuit is designed for testing each one of said plurality of heating elements.

19. A thermal printer according to claim 15, wherein said print head has an aluminum body.

20. A thermal printer according to claim 15, wherein said print head further comprises a circuit board, said circuit board for actuating said set of actuating electronics.
